(19) United States
(12) Patent Application Publication
(10) Pub. No.: US 2009/0036603 A1
(43) Pub. Date: Feb. 5, 2009

(54) CONTINUOUS PRODUCTION METHOD FOR PRODUCING POLYMER RESIN PARTICLE

(75) Inventors: Yasuharu Saita, Tokyo (JP); Kazuya Isobe, Tokyo (JP); Masashi Mamino, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/168,779

(22) Filed: Jul. 7, 2008

(30) Foreign Application Priority Data
Jul. 30, 2007 (JP) JP2007-197204

(51) Int. Cl. C08K 5/42

(52) U.S. Cl. 524/745

(57) ABSTRACT

Disclosed is a method for continuously producing polymer resin particles, including the steps of: introducing a mixed solution of a polymerizable monomer and a chain transfer agent into an aqueous solution of a surface active agent and dispersing a resulting mixture via a mechanical dispersion apparatus to obtain an oil droplet dispersion containing oil droplets exhibiting a median size (D₅₀) of 50 nm-500 μm; feeding the oil droplet dispersion and a solution of a polymerization initiator into a tubular polymerization reactor; polymerizing the polymerizable monomer in the reactor to produce polymer resin particles, wherein the chain transfer agent exhibits a chain transfer constant (Cx) of 1.9-17.1, and the mixed solution of the polymerizable monomer and the polymerization initiator are continuously fed into the reactor and are kept in a plug flow condition in the reactor so as to be polymerized to produce the polymer resin particles.

### CROSS-REFERENCE TO RELATED APPLICATION

The present application is based on Japanese Patent Application No. 2007-197204 filed with Japan Patent Office on Jul. 30, 2007, the entire content of which is hereby incorporated by reference.

### BACKGROUND OF THE INVENTION

1. Technical Field

The present invention relates to a continuous production method for producing a polymer resin particle.

2. Description of Related Art

A reaction apparatus which produces a resin particle via a continuous polymerization requires a uniform residence time in the reaction apparatus to obtain a narrow distribution of molecular weight or particle size of the produced resin particle.

To achieve the narrow distribution, production methods of a resin particle are disclosed, in which a tubular polymerization reactor exhibiting a high plug flow characteristic is employed (refer to, for example, Japanese Patent Application Publication No. 2004-250627). A plug flow is a flow of materials in which the materials are not mixed or diffused in the direction of the flow of materials.

Since it is required to reduce, to the utmost, solution mixing in the direction of solution flow in the tube of the tubular polymerization reactor to secure the targeted plug flow characteristic, any mixing device such as a mixing blade in the tube of the tubular polymerization reactor produces adverse results.

### SUMMARY OF THE INVENTION

However, the present situation is that when a polymerizable monomer, which is in a separated state in a water-based dispersion medium, is provided into a tubular polymerization reactor having no mixing apparatus, the desired polymerization reaction does not occur since the polymerizable monomer is not allowed to form oil droplets, resulting in a failure of continuous production of a polymer resin particle exhibiting a narrow distribution of molecular weight or particle size.

An object of the present invention is to provide a continuous production method, by which a polymer resin particle exhibiting a narrow distribution of molecular weight or particle size can be continuously produced through successive steps so that an oil droplet dispersion incorporating a polymerizable monomer and a chain transfer agent exhibiting a specific chain transfer constant is prepared, and the resulting oil droplet dispersion and a polymerizable initiator are continuously fed into a tubular polymerization reactor to carry out a polymerization reaction while maintaining the plug flow.

The present invention can be achieved with the embodiments below.

An aspect of the present invention is a method for continuously producing polymer resin particles, comprising the steps of:

introducing a mixed solution of a polymerizable monomer and a chain transfer agent into an aqueous solution of a surface active agent and dispersing a resulting mixture via a mechanical dispersion apparatus to obtain an oil droplet dispersion comprising oil droplets exhibiting a median size (D₅₀) of 50 nm-500 μm;

feeding the oil droplet dispersion and a solution of a polymerization initiator into a tubular polymerization reactor;

polymerizing the polymerizable monomer contained in the oil droplet dispersion in the tubular polymerization reactor to produce polymer resin particles,

taking out the polymer resin particles from the tubular polymerization reactor,

wherein the chain transfer agent exhibits a chain transfer constant (Cx) of 1.9-17.1, and the mixed solution of the polymerizable monomer and the polymerization initiator are continuously fed into the tubular polymerization reactor and are kept in a plug flow condition in the tubular polymerization reactor so as to be polymerized to produce the polymer resin particles.

Preferred polymer resin particles produced by the present invention have a weight average molecular weight (Mw) of 10,000 to 200,000, and a ratio of Mw to Mn (Mw/Mn) is 2 to 4, provided that Mn is a number average molecular weight of the polymer resin particles.

A continuous production method of a polymer resin particle of the present invention exhibits an excellent effect of continuously producing a polymer resin particle exhibiting at least one of a narrow distribution of molecular weight and particle size through successive steps so that oil droplet dispersion incorporating a polymerizable monomer and a chain transfer agent exhibiting a specific chain transfer constant is produced, and the resulting oil droplet dispersion and a polymerizable initiator are continuously fed into a tubular polymerization reactor to carry out a polymerization reaction while maintaining the plug flow.

### BRIEF DESCRIPTION OF THE DRAWING

FIG. 1 is a schematic drawing which shows an example of a continuous production apparatus for producing a resin particle employing an oil droplet producing device and a tubular polymerization reactor.

### DESCRIPTION OF THE PREFERRED EMBODIMENTS

The inventors have studied a production apparatus and a production method which continuously produce a polymer resin particle exhibiting a narrow distribution of molecular weight or particle size (hereinafter also simply referred to as a resin particle) employing a tubular polymerization reactor.

As a result of the study, the inventors found that it is possible to continuously produce a polymer resin particle exhibiting a narrow distribution of molecular weight or particle size by employing the following device:

1. A device to prepare an oil droplet dispersion exhibiting a median size (D₅₀) of the oil droplet of 50 nm-500 μm through steps whereby a solution is prepared in which a polymerizable monomer and a chain transfer agent, which exhibits a chain transfer constant (Cx) of 1.9-17.1, are dissolved, and then the resulting solution is dispersed, via a mechanical dispersion apparatus, into an aqueous solution of a surface active agent;

2. A device to continuously feed an oil droplet dispersion and a solution of a polymerization initiator into a tubular polymerization reactor;

3. A device to carry out a polymerization reaction to a desired degree of polymerization while plug flow of a mixed solution of oil droplet dispersion and a solution of a polymerization initiator is maintained to prepare a resin particle; and

4. A device to take out a fluid incorporating the resin particle whose polymerization has been completed.

The present invention is characterized in that a chain transfer agent exhibiting a chain transfer constant (Cx) of 1.9-17.1 is employed.

When a chain transfer agent exhibiting a chain transfer constant (Cx) of 1.9-17.1 is employed, the desired polymerization reaction proceeds until the end point of a plug flow, since a polymerization reaction uniformly proceeds from the beginning to the end of the polymerization reaction with a gradual advance of a chain transfer reaction of the polymerizable monomer during the polymerization reaction.

As a result, a polymer resin particle exhibiting a narrow distribution of molecular weight or particle size can be provided.

In the present invention, an oil droplet dispersion incorporating a polymerizable monomer and a chain transfer agent is used, and a polymerization reaction is carried out by feeding the total amount of the oil droplet dispersion into a tubular polymerization reactor from beginning of the polymerization reaction. Therefore, an excessively large chain transfer constant causes an excessive chain transfer reaction at the initial stage of the polymerization reaction, to result in complete consumption of the chain transfer agent leading to generation of low molecular weight substances. While at the latter stage of the polymerization in which the chain transfer agent was completely consumed, a lot of polymer weight substances are generated due to no chain transfer being occurred, resulting in generation of a polymer resin particle exhibiting a broad molecular weight distribution incorporating both low and high molecular weight substances. Considering the above fact, a chain transfer agent exhibiting a chain transfer constant of not more than 17.1 is employed to achieve a narrow molecular weight distribution. The above chain transfer agent restrains a frequency of chain transfer actions at the initial polymerization stage so that the chain transfer agents remain until the latter polymerization stage and enable the functions thereof.

On the other hand, a chain transfer agent exhibiting a chain transfer constant (Cx) of not less than 1.9 enables functions as a chain transfer agent, whereby the agent can control the molecular weight. Further, no odor problem occurs, since no unreacted chain transfer agent remains on completion of the polymerization reaction.

In the present invention, a resin particle is produced via a polymerization reaction by continuously feeding an oil droplet dispersion incorporating a polymerizable monomer and a chain transfer agent as well as a polymerization initiator into a tubular polymerization reactor. Since the aforesaid tubular polymerization reactor is equipped with no mixing function, it is impossible to carry out redispersion of the oil droplet dispersion which was initially fed into the tubular polymerization reactor, once the dispersion state of the oil droplet dispersion is broken. Therefore, the size of the oil droplets in the oil droplet dispersion is required to be controlled to exhibit the median size (D₅₀) of 50 nm-500 μm, which allows stable dispersion in the tubular polymerization reactor.

A continuous production apparatus of the present invention is detailed below.

### <Continuous Production Apparatus>

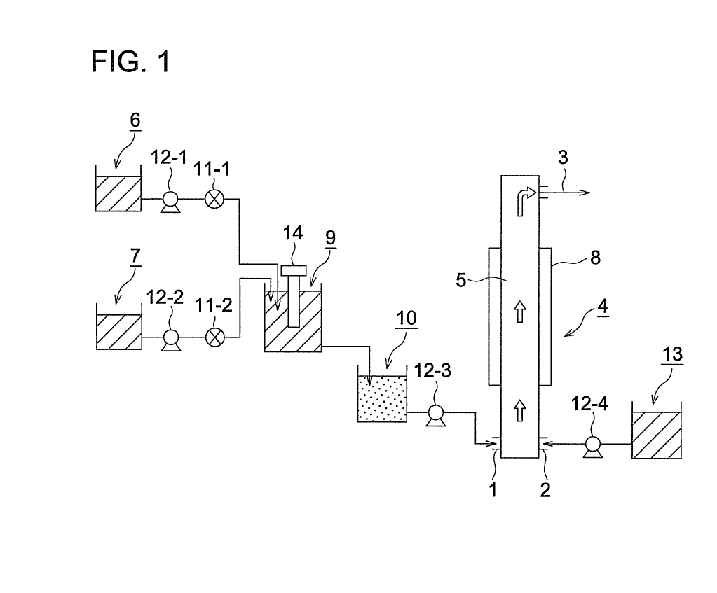

FIG. 1 shows an example of a schematic drawing of a continuous production apparatus of a resin particle employing an oil droplet dispersion preparation apparatus and a tubular polymerization reactor.

In FIG. 1, the cited reference numerals denote:
1: inlet for the oil droplet dispersion;
2: inlet for the polymerization initiator solution;
3: outlet for the resin particle produced via polymerization;
4: tubular polymerization reactor;
5: plug flow section;
6: tank in which a polymerizable monomer and a chain transfer agent are dissolved;
7: tank for the surface active agent solution;
8: heating device;
9: oil droplet dispersion preparation apparatus;
10: stock tank for the oil droplet dispersion;
11-1: valve;
11-2: another valve;
12-1 through 12-4: metering pumps;
13: tank for the polymerization initiator solution; and
14: oil droplet dispersion preparation apparatus.

### <Preparation Apparatus of Oil Droplet Dispersion>

To prepare an oil droplet dispersion exhibiting a specific oil droplet size, an oil droplet dispersion preparation apparatus is employed, in which a polymerizable monomer and a chain transfer agent are dissolved in a solution, and the resulting solution is dispersed into a surface active agent solution.

Such oil droplet dispersion preparation apparatuses include, for example, mechanical dispersing apparatuses, such as a mixer equipped with a high speed rotor (e.g., CLEARMIX, produced by M-Technique Co., Ltd.), an ultrasonic dispersing apparatus, a mechanical homogenizer, a Manton-Gaulin homogenizer, and a pressure homogenizer. Of these, the ultrasonic dispersing apparatus, which enables easy achievement of the targeted oil droplet size, is preferred.

Since an oil droplet size depends on the shape of a vibration element and the output of an ultrasonic dispersing apparatus, a solution formula to prepare an oil droplet or an aqueous solution formula of a surface active agent, the processing conditions of the oil droplet dispersion preparation apparatus are appropriately regulated to achieve the targeted oil droplet size.

An oil droplet exhibiting a volume based median size, in the dispersed state, of 50 nm-500 μm, preferably 70 nm-300 μm, is typically employed. Oil droplets whose sizes are controlled to remain within the above size range stably remain dispersed.

The determination of the oil droplet size may be performed via a commercially available particle size measuring apparatus which uses methods such as a light scattering method, a laser diffraction scattering method, and a laser Doppler method. As a specific particle size measuring apparatus, MICROTRACK MT3300 (manufactured by Nikkiso Co., Ltd.) is usable.

### <Tubular Polymerization Reactor>

The tubular polymerization reactor of the present invention is composed of the following major sub-systems:

1. A sub-system to feed an oil droplet dispersion and a polymerization initiator solution into the tubular polymerization reactor (see reference numerals 1 and 2 of FIG. 1).
2. A sub-system where the fed solution is subjected to a plug flow while heated via a heating device to produce a resin particle via polymerization reaction.
3. A sub-system to take out the solution incorporating the resin particle (see reference numeral 3 of FIG. 1).

An example of the size of each component of the tubular polymerization reactor, shown in FIG. 1, is described below. A ratio of a flow speed to a tube diameter is one of the most important factors to achieve a plug flow condition in a tubular reactor. This value is preferably 20 or more in the present invention.

tube size D (interior diameter): 0.01 m

tube length L: 20 m

tube wall thickness: 0.001 mm

tube length L/tube size D (interior diameter)=2000

It is necessary to minimize any disturbance of the flow along the flow axis in the reaction apparatus to make a uniform flow to maintain a plug flow characteristic. To achieve it, it is necessary to exclude factors which cause the disturbance. For example, it is preferable that the tubular polymerization reactor is designed so that the uniform axial flow is performed by taking measures such as maintaining a uniform temperature in the reaction apparatus by increasing the heat transfer area through increasing the ratio of tube length L/tube size D, since uneven temperature distribution in the reaction apparatus results in heat convection, and making the interior wall surface of the reaction apparatus uniform.

In production of resin particles via the tubular polymerization reactor, conditions such as a residence time in the tubular polymerization reactor, polymerization reaction temperature, and raw materials feeding rate are set so that the targeted resin particle can be produced. Specifically, it is preferable that the above conditions are set within the ranges given below.

Residence time in the tubular polymerization reactor: 5-200 min. (preferably 10-120 min.)

Polymerization reaction temperature: 60-98° C.

Raw materials feeding rate: 4-160 cm³/min.

The above polymerization conditions are appropriately set depending on types and amounts to be used of the polymerizable monomer, the chain transfer agent, the surface active agent, and the polymerization initiator.

Next, a continuous production method of the resin particle of the present invention is described.

Resin particles of the present invention are produced through the following steps:

1. a step where a polymerizable monomer and a reaction transfer agent are blended and dissolved, and the resulting solution is stored in a tank;

2. a step where a surface active agent is dissolved in water, and the resulting solution is stored in a tank;

3. a step where the solution, in which a polymerizable monomer and a reaction transfer agent are blended and dissolved, and the aqueous solution of a surface active agent are introduced into an oil droplet dispersion preparation apparatus through valves, and then oil droplet dispersion exhibiting the oil droplet size of 50 nm-500 μm is prepared via a dispersing apparatus;

4. a step where the oil droplet dispersion is temporarily stored in a tank;

5. a step where resin particles are produced in such a manner that the oil droplet dispersion in the stock tank and the polymerization initiator are dissolved, and the resulting solution is continuously introduced into the tubular polymerization reactor through valves, after which continuous polymerization is carried out by regulating conditions such as residence time in the tubular polymerization reactor, polymerization reaction temperature (T), and raw material feeding rate;

6. a step where the resulting solution incorporating the resin particles is taken out via an outlet.

The resin particles of the present invention are produced via polymerization, through the reaction of a polymerization initiator, of oil droplets which were produced via dispersion of a solution incorporating a polymerizable monomer and a reaction transfer agent into an aqueous solution of a surface active agent.

A polymerizable monomer, a reaction transfer agent, a surface active agent, and a polymerizable initiator, all of which are employed in production of a resin particle, are described below.

### (Polymerizable Monomer)

Resin particles of the present invention are composed of a polymer obtained via polymerization of at least one type of polymerizable monomer. The above-described polymerizable monomers include styrene or styrene derivatives, such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene; methacrylic acid ester derivatives, such as methyl methacrylate, ethyl methacrylate, n-butyl methacrylate, iso-propyl methacrylate, iso-butyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; acrylic acid ester derivatives, such as methyl acrylate, ethyl acrylate, iso-propyl acrylate, n-butyl acrylate, t-butyl acrylate, iso-butyl acrylate, n-octyl acrylate, 2-ethylhexyl acrylate, stearyl acrylate, lauryl acrylate, and phenyl acrylate; olefins, such as ethylene, propylene, and isobutylene; vinyl esters, such as vinyl propionate, vinyl acetate, and vinyl benzoate; vinyl ethers, such as vinyl methyl ether, and vinyl ethyl ether; vinyl ketones, such as vinyl methyl ketone, vinyl ethyl ketone, and vinyl hexyl ketone; N-vinyl compounds, such as N-vinyl carbazole, N-vinyl indole, and N-vinyl pyrrolidone; vinyl compounds, such as vinylnaphthalene, and vinylpyridine; and acrylic acids or methacrylic acid derivatives, such as acrylonitrile, methacrylonitrile, and acrylamide. These vinyl monomers may be used either individually or in combinations thereof.

Further, a polymerizable monomer featuring an ionic dissociable group is preferably combined with the above monomer to constitute the resin. Examples of such polymerizable monomers are those having a substituent such as a carboxyl group, a sulfonic acid group, and a phosphoric acid group as the constituting group of the monomer. Specific examples of such polymerizable monomers include acrylic acid, methacrylic acid, maleic acid, itaconic acid, cinnamic acid, fumaric acid, maleic acid mono-alkyl ester, itaconic acid mono-alkyl ester, styrenesulfonic acid, allylsufosuccinic acid, 2-acrylamido-2-methylpropane sulfonic acid, acid phosphooxyethyl methacrylate, and 3-chloro-2-acid-phosphooxypropyl methacrylate.

Further, resins featuring a crosslinked structure using multi-functional vinyls are usable. Examples of such multi-functional vinyls include divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, and neopentyl glycol diacrylate.

The resin particles of the present invention are produced via polymerization of the aforesaid polymerizable monomer. Radical polymerization initiators usable at beginning of the polymerization are listed below. Specific examples of oil soluble polymerization initiators include azo type or diazo type polymerization initiators such as 2,2′-azobis-(2,4-dimethylvaleronitrile), 2,2′-azobisisobutyronitrile, 1,1′-azobis-(cyclohexane-1-carbonitrile), 2,2′-azobis-4-methoxy-2,4-dimethylvaleronitrile, and azobisisobutyronitrile; peroxide type polymerization initiators such as benzoyl peroxide, methylethylketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane, and tris-(t-butylperoxy)triazine; and polymer initiators having peroxide in side chains.

### (Chain Transfer Agent)

A chain transfer agent exhibiting a chain transfer constant (Cx) of 1.9-17.1, preferably 2.0-14.0, is employed during formation of resin particles.

The use of the chain transfer agent exhibiting a chain transfer constant of the above region effectively affects production, in the tubular polymerization reactor, of the resin particles exhibiting a targeted ratio between a weight average molecular weight (Mw) and a number average molecular weight (Mn), that is, a ratio of Mw/Mn.

“Chain transfer constant” refers to the ratio between a reaction rate constant of a chain transfer during radical polymerization and a rate constant of growth reaction. The chain transfer constant is defined by formulae below.

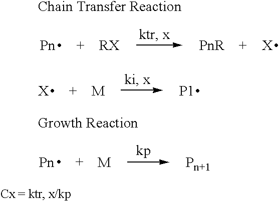

wherein the cited designations represents:

Cx: chain transfer constant

ktr, x: rate constant of a chain transfer reaction

ki: reaction rate constant at the start of a chain reaction

kp: growth reaction rate constant

Pn•: polymer radical having a number of “In” chains (n=1, 2, 3 . . . )

RX: chain transfer agent

M: polymerizable monomer

X•: chain transfer radical

The chain transfer constant may be also represented, as described below, by a ratio of differences of decreases in a chain transfer agent and a polymerizable monomer (that is, a degree of difference of decreases). The chain transfer constant defined in the manner described above is calculated by the formula below, and the value must agree with the one calculated by the above-described formula.

Cx=d log [RSH]/d log [M]

wherein RSH, M, and Cx represent the remaining concentration of a chain transfer agent, the remaining concentration of a polymerizable monomer, and the chain transfer constant, respectively.

The chain transfer constant of the present invention indicates one obtained at 50° C. employing a styrene as the polymerizable monomer.

Practically, chain transfer constant values, given in the literature (e.g., POLYMER HANDBOOK) or provided by companies which sell the chain transfer agents, may be used.

In case no values thereof can be found in the literature, the values may be calculated through an experiment. The calculation is carried out in such a manner that at least four concentration levels of the chain transfer agent including zero level are taken, and bulk polymerization of a styrene is carried out at 60° C. employing a initiator and an AIBN (azobisisobutyronitrile) in the presence of the chain transfer agent at each concentration level.

The reduced amount of the chain transfer agent is determined via a capillary column (HR-1), and the additive rate of the polymerizable monomer and a molecular weight of a polymer are determined via GPC to calculate the chain transfer constant value.

As chain transfer agents usable in the present invention, any agents may be usable as long as it exhibits the chain transfer constant of 1.9-17.1 at 50° C. Examples thereof are listed below.

| | |
|---|---|
| 1-octanethiol | 16.0 |
| Ethanethiol | 17.1 |
| t-octylmercaptan | 4.3 |
| t-dodecylmercaptan | 5.0 |
| benzthiazole | 2.1 |

The amount of the chain transfer agent to be used is preferably 0.5-5.0% by mass with respect to 100 parts by mass of the polymerizable monomer.

### (Polymerization Initiator)

In the present invention, as a polymerizable initiator employable in the polymerization of the aforesaid polymerizable monomer, inorganic peroxides such as persulfate salts including potassium persulfate and ammonium persulfate, and hydrogen peroxide are usable. Of these inorganic peroxides, hydrogen peroxide is preferred. A weight ratio of the oil droplet dispersion to the polymerization initiator in the present invention is preferably from 3 to 10.

Further, organic polymerization initiators, such as a salt of azobisamidinopropane acetate, and azobiscyanovaleric acid and salts thereof, are also usable.

It is preferable that the amount of the polymerizable initiator is 0.1-10.0% by mass with respect to 100 parts by mass of the polymerizable monomer.

### (Surface Active Agent)

A surface active agent is employed to disperse a solution incorporating a polymerizable monomer and a chain transfer agent into an aqueous solution to form oil droplets. Examples of the preferred surface active agents include, but are not particularly limited to, the ionic surface active agents listed below.

Examples of the ionic surface active agents include sulfonic acid salts (such as sodium dodecylbenzenesulfonate, sodium arylalkyl polyethersulfonate, sodium 3,3-disulfondiphenylurea-4,4-diazo-bis-amino-8-naphthol-6-sulfonate, ortho-caroxybenzene-azo-dimethylaniline, and sodium 2,2,5,5-tetramethyl-triphenylmethane-4,4-diazi-bis-β-naphthol-6-sulfonate); sulfuric acid ester salts (such as sodium dodecylsulfate, sodium tetradecylsulfate, sodium pentadecylsulfate, and sodium octylsulfate); as well as fatty acid salts (such as sodium oleate, sodium laurate, sodium caprate, sodium caprylate, sodium caproate, potassium stearate, and calcium oleate).

Further, a nonionic surface active agent may also be employed. Specific examples of the nonionic surface active agent include polyethylene oxide, polypropylene oxide, a combination of polypropylene oxide and polyethylene oxide, esters of polyethylene glycol with higher fatty acids, alkylphenol polyethylene oxide, esters of higher fatty acids with polyethylene glycol, esters of higher fatty acids with polypropylene oxides, and sorbitan esters.

Subsequently, characteristics of a resin particle are described.

### (Ratio of Weight Average Molecular Weight (Mw) to Number Average Molecular Weight (Mn))

Resin particles exhibiting an almost equal degree of polymerization may be provided via polymerization employing the continuous production apparatus of the present invention, in which the weight average molecular weight (Mw) is 10,000-200,000, and the ratio between weight average molecular weight (Mw) and number average molecular weight (Mn), (Mw/Mn) is 2-4.

Molecular weight of the resin particles may be determined via, for example, gel permeation chromatography (GPC) employing a tetrahydrofuran (THF) as a column solvent.

The specific determination method is that 1 ml of the THF is added to 1 mg of a measured sample, and the solution is stirred using a magnetic stirrer at room temperature to sufficiently dissolve the sample, and then, the resulting solution is subjected to filtration through a membrane filter having a pore size of 0.45-0.50 μm, followed by injection into the GPC. The GPC measurement is carried out under measurement conditions in which the column is stabilized at 40° C., the THF is introduced at a flow rate of 1 ml/min., and about 100 μl of the sample having a concentration of 1 mg/ml is injected therein. Combinations of commercially available polystyrene gel columns are preferably employed. Examples of the column include combinations of Shodex GPC KF-801, 802, 803, 804, 805, 806 and 807, which are manufactured by Showa Denko Co., Ltd., or combinations of TSK gel G1000H, G2000H, G3000H, G4000H, G5000H, G6000H, G7000H and TSK guard column, which are manufactured by Tosoh Co., Ltd.

As a detector, a refractive index detector (RI detector) or a UV detector is preferably employed. In the determination of the molecular weight of samples, the molecular weight distribution of the sample is calculated employing a calibration curve which is prepared employing monodispersed polystyrene standard particles. About ten types of such polystyrene standard particles are preferably used to prepare the calibration curve.

### (Particle Size and Coefficient of Variation)

The particle size of resin particles to be provided may be 50 nm-500 μm with respect to volume based median size (D₅₀). “Volume based median size” denotes a particle size where a counted number (e.g., accumulative frequency) corresponds to 50% of the total number of particles, where the number of particle size exhibiting a specific volume is counted in descending order or in ascending order.

The coefficient of variation, (hereinafter also referred to as CV value) in the volume based particle distribution of the resin particles constituting the resin particles to be provided, may be 2-20%. Particle distribution of resin particles exhibiting the coefficient of variation of the above region becomes narrow.

The coefficient of variation of resin particles in the volume based particle distribution may be calculated by the formula below.

Coefficient of variation (Cv value)(%)=(standard deviation in volume based particle distribution)/(volume based median size (D₅₀))×100

The volume based median size (D₅₀) and the coefficient of variation (CV value) of the resin particle of the present invention are measured and calculated via an apparatus, such as Multisizer III (manufactured by Beckman Coulter Inc.) connected with a computer system for data processing (also manufactured by Beckman Coulter Inc.).

The aforesaid measurement is carried out as follows: 0.02 g of a resin particle is soaked in 20 ml of surface active agent solution, which is employed for the purpose of dispersion of the resin particle and is prepared, for example, by diluting a neutral detergent containing a component of surface active agent by a factor of 10 in pure water, and the resulting mixture is subjected to an ultrasonic dispersion for one minute to prepare a resin particle dispersion. Then the resin particle dispersion is charged using a pipette into a beaker containing an electrolyte (ISOTON II: produced by Beckman Coulter Inc.), placed on a sample stand, to achieve a measured concentration of 8%, followed by measurement with the count of the measuring apparatus set to 2,500. The aperture diameter of a Coulter Multisizer is set to 700 μm.

Continuous production apparatus of the resin particle of the present invention is suitable for the production of the resin particle exhibiting the aforesaid values of the volume based median size (D50) and the CV value.

Resin particles produced according to the present invention are usable for, as examples, a toner, and a spacer used in a liquid crystal.

### EXAMPLES

The invention is detailed below with reference to examples, but the invention is not limited to them.

### Example 1

Resin particles were produced via the steps below, employing the continuous production apparatus of resin particles as shown in previously described FIG. 1.

### (1) Preparation of Surface Active Agent Solution

The materials below were blended and dissolved to prepare a surface active agent solution.

| | |
|---|---|
| sodium dodecylsulfate | 0.82 parts by mass |
| ionized water | 539.18 parts by mass |

### (2) Preparation of Polymerizable Monomer Solution

The materials below were blended and dissolved to prepare a polymerizable monomer solution.

| | |
|---|---|
| Styrene | 67.7 parts by mass |
| n-butyl acrylate | 19.9 parts by mass |
| methacrylic acid | 10.9 parts by mass |
| t-octylmercaptan (Cx: 4.3) | 2.2 parts by mass |

### (3) Preparation of Oil Droplet Dispersion

The polymerizable monomer solution prepared above was dispersed in the surface active agent solution employing a mechanical dispersion apparatus (US homogenizer 300T: manufactured by Nissei Corp.) to an oil droplet size of 100 nm, to prepare the oil droplet dispersion.

### (4) Preparation of Polymerization Initiator Solution

The materials below were blended and dissolved to prepare a polymerization initiator solution.

| | |
|---|---|
| polymerization initiator (potassium persulfate) | 9.2 parts by mass |
| ionized water | 200 parts by mass |

### (5) Polymerization Step

A tubular polymerization reactor, which is a part of the continuous production apparatus of a resin particle as shown in the aforesaid FIG. 1, exhibiting the tube size, the tube length, and the tube wall thickness given below was provided.

tube size D (interior diameter): 0.01 m

tube length L: 20 m

tube wall thickness: 0.001 m

The oil droplet dispersion prepared above was continuously introduced at a rate of 16.8 cm³/min. through the inlet of an oil droplet dispersion 1 which is arranged at the tubular polymerization reactor 4 as shown in FIG. 1, and polymerization initiator solution was continuously introduced at a rate of 3.2 cm³/min. through the inlet for polymerization initiator solution 2, and then the interior temperature and residence time of the plug flow section 5 were set to 80° C. and 40 min. respectively, followed by carrying out of continuous polymerization to prepare resin particles, which are referred to as “Resin Particle 1”.

### Example 2

Resin particles were prepared in the same manner as in Example 1 except that the tube size, the tube length, and the tube wall thickness of the tubular polymerization reactor employed in Example 1 were changed to those described below. The prepared resin particles are referred to as “Resin Particle 2”.

tube size D (interior diameter): 0.005 m

tube length L: 40 m

tube wall thickness: 0.001 m

### Example 3

Resin Particles 3 were prepared in the same manner as in Example 1 except that the chain transfer agent was changed from t-octylmercaptan, used in Example 1, to 2,2′-dithio-bisbenzthiazole.

### Example 4

Resin Particles 4 were prepared in the same manner as in Example 1 except that the chain transfer agent was changed from t-octylmercaptan, used in Example 1, to ethanethiol.

### Example 5

Conditions of the mechanical dispersion apparatus (US homogenizer 300T: manufactured by Nissei Corp.) were changed to prepare oil droplet dispersion exhibiting an oil droplet size of 50 nm.

Resin Particles 5 were prepared in the same manner as in Example 1 except that the chain transfer agent was changed from t-octylmercaptan, used in Example 1, to t-dodecymercaptan and the oil droplet dispersion exhibiting an oil droplet size of 100 nm, used in Example 1, was changed to the oil droplet dispersion exhibiting an oil droplet size of 50 nm, prepared as above.

### Example 6

Conditions of the mechanical dispersion apparatus (US homogenizer 300T: manufactured by Nissei Corp.) were changed to prepare oil droplet dispersion exhibiting an oil droplet size of 500 nm.

Resin Particles 6 were prepared in the same manner as in Example 1 except that the chain transfer agent was changed from t-octylmercaptan, used in Example 1, to t-dodecymercaptan and the oil droplet dispersion exhibiting an oil droplet size of 100 nm, used in Example 1, was changed to the oil droplet dispersion exhibiting an oil droplet size of 500 nm, prepared as above.

### Comparative Example 1

Resin Particles 7 were prepared in the same manner as in Example 1 except that the chain transfer agent was changed from t-octylmercaptan, used in Example 1, to p-toluenethiol.

### Comparative Example 2

Resin Particles 8 were prepared in the same manner as in Example 1 except that the chain transfer agent was changed from t-octylmercaptan, used in Example 1, to n-octylmercaptan.

### Comparative Example 3

Conditions of the mechanical dispersion apparatus (US homogenizer 300T: manufactured by Nissei Corp.) were changed to prepare the oil droplet dispersion exhibiting an oil droplet size of 50 nm.

Resin Particles 9 were prepared in the same manner as in Example 1 except that the oil droplet dispersion exhibiting an oil droplet size of 100 nm, used in Example 1, was changed to the oil droplet dispersion exhibiting an oil droplet size of 40 nm, prepared as above.

### Comparative Example 4

Conditions of the mechanical dispersion apparatus (US homogenizer 300T: manufactured by Nissei Corp.) were changed to prepare the oil droplet dispersion exhibiting an oil droplet size of 550 nm.

Resin Particles 10 were prepared in the same manner as in Example 1 except that the oil droplet dispersion exhibiting an oil droplet size of 100 nm, used in Example 1, was changed to the oil droplet dispersion exhibiting an oil droplet size of 550 nm, prepared as above.

Table 1 shows sizes of the oil droplet dispersions, types of the chain transfer agents, and setting conditions of the tubular polymerization reactor employed in the preparations of Resin Particles of Inventive Examples and Comparative Examples.

TABLE 1

| | Oil | Tubular polymerization reactor | | | | | | | |
|---|---|---|---|---|---|---|---|---|---|
| | droplet | | | | | Raw material | | | |
| | preparing | | | | | feeding | | | |
| | apparatus | | | | | rate | | | |
| | Size of | | | | | Oil | Polymerization | | |
| | oil | Chain transfer | | Tube | Tube | droplet | initiator | | Residence |
| | droplet | agent | | diameter | length | dispersion | solution | Temperature | time |
| | dispersion | Compound | Cx | (m) | (m) | (cm³/min.) | (cm³/min.) | (° C.) | (min.) |
| Example 1 | 100 nm | t-octylmercaptan | 4.3 | 0.01 | 20 | 16.8 | 3.2 | 80 | 80 |
| Example 2 | 100 nm | t-octylmercaptan | 4.3 | 0.005 | 40 | 33.6 | 6.4 | 80 | 20 |
| Example 3 | 100 nm | 2,2′-dithiobis- | 2.1 | 0.01 | 20 | 16.8 | 3.2 | 80 | 160 |
| | | benzthiazole | | | | | | | |
| Example 4 | 100 nm | ethanethiol | 17.1 | 0.01 | 20 | 16.8 | 3.2 | 80 | 160 |
| Example 5 | 50 nm | t-dodecylmercaptan | 5 | 0.01 | 20 | 16.8 | 3.2 | 80 | 160 |
| Example 6 | 500 nm | t-dodecylmercaptan | 5 | 0.01 | 20 | 16.8 | 3.2 | 80 | 160 |
| Comp. 1 | 100 nm | p-toluenethiol | 1 | 0.01 | 20 | 16.8 | 3.2 | 80 | 160 |
| Comp. 2 | 100 nm | n-octylmercaptan | 19 | 0.01 | 20 | 16.8 | 3.2 | 80 | 160 |
| Comp. 3 | 40 nm | t-octylmercaptan | 4.3 | 0.01 | 20 | 16.8 | 3.2 | 80 | 160 |
| Comp. 4 | 550 nm | t-octylmercaptan | 4.3 | 0.01 | 20 | 33.6 | 6.4 | 90 | 80 |

Comp.: Comparative Example

Table 2 shows Mw, Mw/Mn, particle size, and CV value of the resulted particles.

TABLE 2

| | | | Particle | | CV |
|---|---|---|---|---|---|
| | Mw | Mw/Mn | size | | value |
| Example 1 | 10700 | 2.2 | 75 | nm | 15% |
| Example 2 | 12200 | 2.7 | 69 | nm | 14% |
| Example 3 | 92000 | 2.1 | 117 | nm | 9% |
| Example 4 | 34500 | 3.8 | 48 | nm | 10% |
| Example 5 | 20500 | 2.6 | 90 | nm | 11% |
| Example 6 | 47000 | 2.4 | 170 | μm | 19% |
| Comparative | 100900 | 5.2 | 75 | nm | 20% |
| example 1 | | | | | |
| Comparative | 50300 | 9.7 | 52 | nm | 19% |
| example 2 | | | | | |
| Comparative | 17800 | 6 | 40 | nm | 13% |
| example 3 | | | | | |
| Comparative | 62800 | 4.6 | 190 | μm | 26% |
| example 4 | | | | | |

Table 2 shows that values of Resin Particles 1-6 prepared in Examples 1-6 fall within each range of: weight average molecular weight (Mw) being 10,000-200,000; ratio (Mw/Mn) between a weight average molecular weight (Mw) and a number average molecular weight (Mn) being 2-4; volume based median size (D₅₀) being 50 nm-500 μm; and coefficient of variation (CV value) in volume based particle distribution of resin particles being 2-20%. As is clear from Table 2, Examples 1-6 exhibits an excellent effect of continuously producing a polymer resin particle exhibiting one or both of a narrow distribution of molecular weight and particle size compared to Resin Particles 7-10 of Comparative Examples 1-4.

The values of Mw, Mw/Mn, particle size, and CV value, given in Table 2 were determined via the aforesaid methods.

What is claimed is:

1. A method for continuously producing polymer resin particles, comprising the steps of:
introducing a mixed solution of a polymerizable monomer and a chain transfer agent into an aqueous solution of a surface active agent and dispersing a resulting mixture via a mechanical dispersion apparatus to obtain an oil droplet dispersion comprising oil droplets exhibiting a median size (D₅₀) of 50 nm-500 μm;
feeding the oil droplet dispersion and a solution of a polymerization initiator into a tubular polymerization reactor;
polymerizing the polymerizable monomer contained in the oil droplet dispersion in the tubular polymerization reactor to produce polymer resin particles,
taking out the polymer resin particles from the tubular polymerization reactor,
wherein the chain transfer agent exhibits a chain transfer constant (Cx) of 1.9-17.1, and the mixed solution of the polymerizable monomer and the polymerization initiator are continuously fed into the tubular polymerization reactor and are kept in a plug flow condition in the tubular polymerization reactor so as to be polymerized to produce the polymer resin particles.

2. The method for continuously producing the polymer resin particles of claim 1,
wherein the polymer resin particles have a weight average molecular weight (Mw) of 10,000 to 200,000, and a ratio of Mw to Mn (Mw/Mn) is 2 to 4, provided that Mn is a number average molecular weight.

3. The method for continuously producing the polymer resin particles of claim 1,
wherein the oil droplet dispersion prepared via the mechanical dispersion apparatus has a median size (D₅₀) of 70 nm-300 μm.

4. The method for continuously producing the polymer resin particles of claim 1,
wherein the chain transfer agent exhibits a chain transfer constant (Cx) of 2.0-14.0.

5. The method for continuously producing the polymer resin particles of claim 1,
wherein an amount of the chain transfer agent is 0.5 to 5.0 weight % based on the weight of polymerizable monomer.

6. The method for continuously producing the polymer resin particles of claim 1,
wherein the polymerization initiator includes at least one of an inorganic peroxide compound and an organic peroxide compound.

7. The method for continuously producing the polymer resin particles of claim 6,
wherein the polymerization initiator includes at least one of a persulfate salt and hydrogen peroxide.

8. The method for continuously producing the polymer resin particles of claim 7,
wherein the polymerization initiator includes at least one of a salt of azobis-amidinopropane acetate, azobiscyanovaleric acid and a salt of azobiscyanovaleric acid.

9. The method for continuously producing the polymer resin particles of claim 1,
wherein an amount of the polymerization initiator is 0.1 to 10.0 weights based on the weight of the polymerizable monomer.

10. The method for continuously producing the polymer resin particles of claim 1,
wherein the surface active agent is an ionic surface active agent.

11. The method for continuously producing the polymer resin particles of claim 1,
wherein the polymer resin particles have a coefficient of variation of 2 to 20%.

12. The method for continuously producing the polymer resin particles of claim 1,
wherein the polymerizing step polymerizes the polymerizable monomer contained in the oil droplet dispersion in the tubular polymerization reactor to produce polymer resin particles for 5-200 min.

13. The method for continuously producing the polymer resin particles of claim 1,
wherein the feeding step feeds the oil droplet dispersion and the solution of the polymerization initiator into the tubular polymerization reactor in a feeding rate of 4-160 cm³/min.

14. The method for continuously producing the polymer resin particles of claim 2,
wherein the oil droplet dispersion prepared via the mechanical dispersion apparatus has a median size (D₅₀) of 70 nm-300 μm, and the chain transfer agent exhibits a chain transfer constant (Cx) of 2.0-14.0.
